(19) United States
(12) Patent Application Publication
(10) Pub. No.: US 2022/0361083 A1
(43) Pub. Date: Nov. 10, 2022

(54) RADIO COMMUNICATION APPARATUS, RADIO COMMUNICATION METHOD, AND RADIO COMMUNICATION SYSTEM

(71) Applicant: Panasonic Intellectual Property Management Co., Ltd., Osaka (JP)

(72) Inventors: Tomohiro MURATA, Kanagawa (JP); Naganori SHIRAKATA, Kanagawa (JP)

(21) Appl. No.: 17/872,862

(22) Filed: Jul. 25, 2022

Related U.S. Application Data
(63) Continuation of application No. PCT/JP2020/043019, filed on Nov. 18, 2020.

(30) Foreign Application Priority Data
Jan. 31, 2020 (JP) 2020-014839

(51) Int. Cl. H04W 40/12; H04W 28/10; H04W 28/02

(52) U.S. Cl. CPC H04W 40/12; H04W 28/10; H04W 28/0215; H04W 28/0236; H04W 84/18

(57) ABSTRACT

A radio communication apparatus in a wireless mesh network includes reception circuitry, which, in operation, receives a radio signal; and control circuitry, which, in operation, determines a candidate radio device that is not selected as a forwarding destination of the received radio signal, based on destination information of the received radio signal and information on a group to which another candidate radio device capable of communication belongs.

### TECHNICAL FIELD

The present disclosure relates to a radio communication apparatus, a radio communication method, and a radio communication system.

### BACKGROUND ART

There is a radio communication network (e.g., a wireless mesh network) that performs message forwarding between a plurality of radio devices (also referred to as a node, a radio node, a radio communication device, or a radio communication terminal) (see, e.g., Patent Literature (hereinafter, referred to as “PTL” 1).

### CITATION LIST

### Patent Literature

PTL 1
Japanese Patent Application Laid-Open No. H11-98137

### SUMMARY OF INVENTION

However, in a wireless mesh network, there is room for consideration of the method to enhance transmission efficiency of a radio signal (e.g., also referred to as data or a message).

One non-limiting and exemplary embodiment facilitates providing a radio communication apparatus, a radio communication method and a radio communication system that can enhance transmission efficiency of a signal in a wireless mesh network.

The radio communication apparatus according to the embodiment of the present disclosure is a radio communication apparatus in a wireless mesh network, and includes: reception circuitry, which, in operation, receives a radio signal; and control circuitry, which, in operation, determines a candidate radio device that is not selected as a forwarding destination of the received radio signal, based on destination information of the received radio signal and information on a group to which another candidate radio device capable of communication belongs.

It should be noted that general or specific embodiments may be implemented as a system, an apparatus, a method, an integrated circuit, a computer program, a storage medium, or any selective combination of a system, an apparatus, a method, an integrated circuit, a computer program, and a recording medium.

According to an embodiment of the present disclosure, transmission efficiency of a signal in a wireless mesh network can be enhanced.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram illustrating an exemplary configuration of a radio communication network;

FIG. 2 is a sequence diagram illustrating an operation example of the radio communication network;

FIG. 3 is a diagram illustrating another exemplary configuration of the radio communication network;

FIG. 4 is a block diagram illustrating an exemplary configuration of a radio device;

FIG. 5 is a sequence diagram illustrating another operation example of the radio communication network;

FIG. 6 is a flowchart illustrating an operation example of the radio device;

FIG. 7 is a flowchart illustrating an operation example of a forwarding process;

FIG. 8 is a diagram illustrating a variation of the configuration of the radio communication network; and

FIG. 9 is a sequence diagram illustrating an operation example in the variation of the configuration of the radio communication network.

### DESCRIPTION OF EMBODIMENTS

Hereinafter, embodiments of the present disclosure will be described in detail with reference to the drawings. Note that the embodiments described below are merely examples, and the present disclosure is not limited to the following embodiments.

The number of terminals or sensors equipped with a radio device has been increasing with the rapid development of Internet of Things (IoT). A wireless mesh network is an example of radio communication networks configured by those radio devices. The wireless mesh network has features such as a flexible setting of a reception area and capability of self-repair when communication is partially interrupted, compared with the configuration of other radio communication networks.

It can be expected that a wireless mesh network is configured by a large number of radio devices, for example. Thus, for example, a plurality of radio devices in a wireless mesh network may be grouped into a plurality of groups (e.g., also referred to as a communication group or a radio device group). For example, radio devices having similar properties or qualities (e.g., reception qualities) may be grouped. Examples of radio devices having similar properties may include a plurality of radio devices arranged in the same section.

For example, PTL 1 discloses a method for aggregating communication between groups to a representative device in each group.

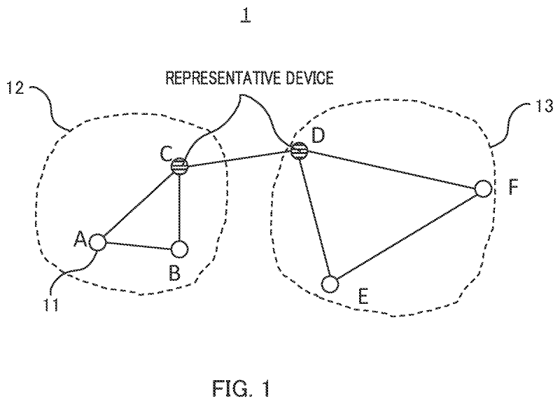

In PTL 1, for example, as illustrated in FIG. 1, a plurality of radio devices 11 (radio devices A to F in FIG. 1) are grouped into one or a plurality of groups (group 12 and group 13 in FIG. 1) in radio communication network 1 (e.g., a wireless mesh network). Also, in PTL 1, for example, as illustrated in FIG. 1, one or a plurality of representative devices (radio devices C and D in FIG. 1) are selected in group 12 and group 13, respectively.

In FIG. 1, each radio device 11 directly communicates with another radio device belonging to the same group as the subject radio device 11 belongs, for example. Also, in FIG. 1, radio device 11 communicates with a radio device belonging to a group different from the group to which the subject radio device 11 belongs through a representative device. For example, when a signal (e.g., a message) is transmitted from radio device A belonging to group 12 to radio device F belonging to group 13 in FIG. 1, the message is transmitted (in other words, forwarded) to radio device C, which is the representative device of group 12, and then radio device C forwards the message (e.g., some or all of the data) to radio device D, which is the representative device of group 13.

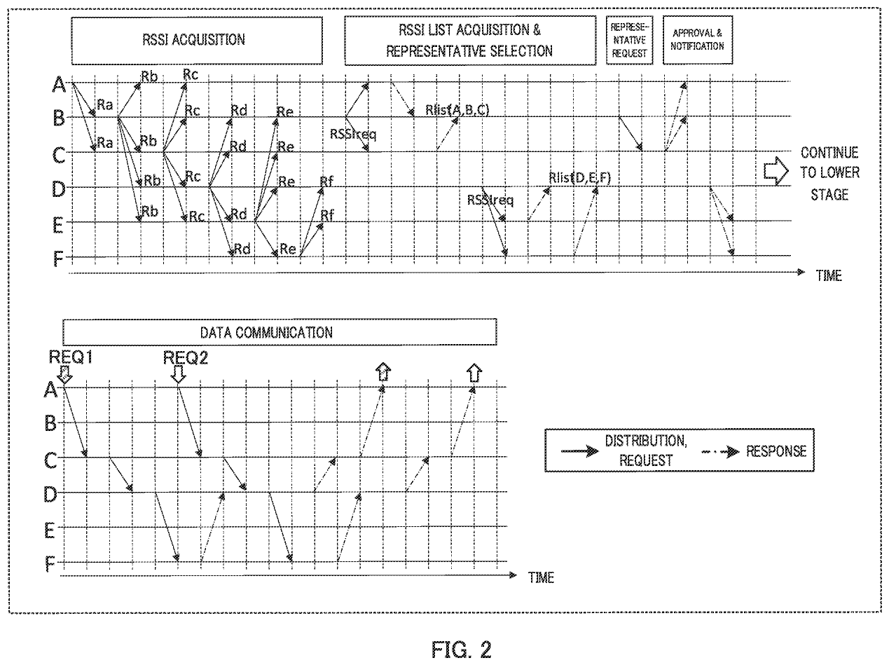

However, the method described in PTL 1 may include a procedure of selecting (in other words, choosing, setting, or deciding) a representative device in each group. FIG. 2 is a sequence diagram illustrating a processing example in the method described in PTL 1. As illustrated in FIG. 2, the following processing related to the selection of a representative device may be included before data communication, for example: collecting information (e.g., “Received Signal Strength Indicator (RSSI) acquisition”), selecting a candidate for the representative device (e.g., “RSSI list acquisition & representative selection”), requesting the candidate for the representative device to operate as a representative device (e.g., “representative request”), and accepting the request and notifying another radio device in the group (e.g., “approval & notification”).

By the selection process of the representative device, for example, the time until data communication starts (in other words, the time until being in a communicable state) may be increased.

Further, in the method described in PTL 1, for example, since communication (in other words, traffic or communication load) tends to be concentrated on the representative device in each group, the communication speed (or system throughput) may be lowered.

In one embodiment of the present disclosure, for example, a method for communicating between a plurality of groups without selecting a representative device in a wireless mesh network will be described. According to the embodiment of the present disclosure, for example, since a representative device is not selected, the time until data communication starts can be shortened as compared with the method disclosed in PTL 1. In addition, according to the embodiment of the present disclosure, since a representative device is not selected in each group, the communication can be easily dispersed and thus the communication speed (or the system throughput) can be enhanced.

[Exemplary Configuration of Radio Communication Network]

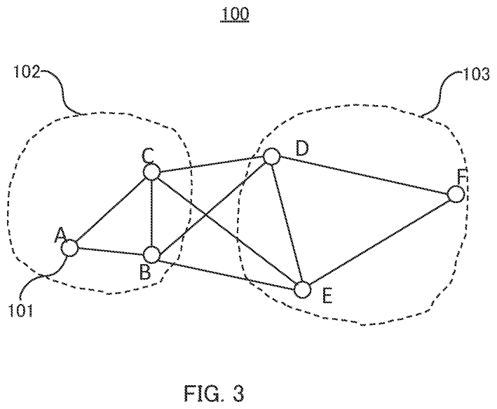

FIG. 3 is a diagram illustrating an exemplary configuration of radio communication network (in other words, radio communication system) 100 according to the embodiment of the present disclosure. Radio communication network 100 is, for example, a wireless mesh network.

FIG. 3 is a diagram schematically illustrating an arrangement (in other words, a topology) of six radio devices 101, radio devices A to F, included in radio communication network 100.

Each of radio devices A to F included in radio communication network 100 illustrated in FIG. 3 is grouped into either group 102 or group 103. In FIG. 3, for example, radio devices A, B, and C belong to group 102, and radio devices D, E, and F belong to group 103.

The lines connecting radio devices 101 illustrated in FIG. 3 illustrates the relation example of radio devices that can communicate by radio. For example, in FIG. 3, radio device A may communicate by radio with each of radio devices B and C; radio device B may communicate by radio with each of radio devices A, C, D and E; radio device C may communicate by radio with each of radio devices A, B, D and E; radio device D may communicate by radio with each of radio devices B, C, E and F; radio device E may communicate by radio with each of radio devices B, C, D and F; and radio device F may communicate by radio with each of radio devices D and E.

Thus, in the example illustrated in FIG. 3, radio device B, C, D and E can communicate with a radio device in another group in addition to a radio device in the group to which each of radio devices B, C, D and E belongs. On the other hand, radio devices A and F can communicate with a radio device in the group to which each of radio devices A and B belongs, but do not communicate directly with a radio device in another group.

Further, in the following description, as an example, the creator of the message (e.g., the user of radio device 101) knows that the communication terminal (e.g., radio device 101) that inputs the message and the communication terminal (e.g., radio device 101) that is the destination of the message exist in radio communication network 100.

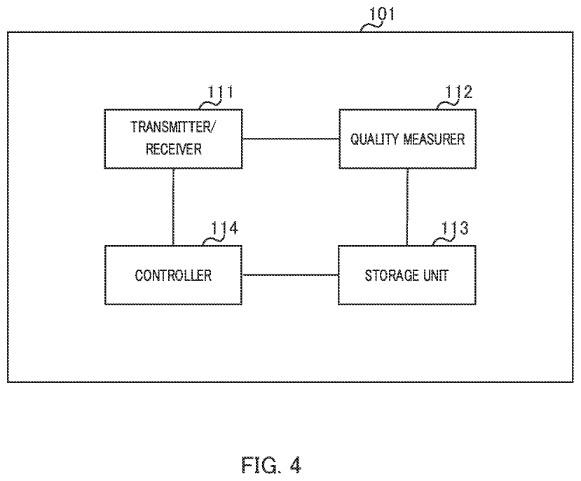

FIG. 4 is a block diagram illustrating an exemplary configuration of radio device 101 according to the embodiment of the present disclosure. Each of radio devices A to F illustrated in FIG. 3 may, for example, include the configuration of radio device 101 illustrated in FIG. 4.

Radio device 101 illustrated in FIG. 4 may include, for example, transmitter/receiver 111, quality measurer 112, storage unit 113, and controller 114.

Transmitter/receiver 111 performs, for example, at least one of radio transmission and radio reception of a signal (e.g., also referred to as data or a message). For example, transmitter/receiver 111 (e.g., corresponding to reception circuitry) may receive a message addressed to another radio device. Further, for example, transmitter/receiver 111 (e.g., corresponding to transmission circuitry) may forward the received message addressed to another radio device. Transmitter/receiver 111 may decide the transmission and reception of a message under the control of controller 114, for example. Note that the radio communication system in transmitter/receiver 111 may be, for example, a radio local area network (LAN: Local Area Network), Bluetooth (registered trademark), or a system using a millimeter wave band (e.g., WiGig (registered trademark)), or may be another radio communication system.

Quality measurer 112 measures, for example, the quality (e.g., reception quality) of the propagation path between radio device 101 and another radio device based on the signal received from another radio device. The reception quality may be, for example, an RSSI (received signal strength). Note that the reception quality (or the log collected) is not limited to an RSSI, and may be information on the quality of the received signal such as Signal to Noise Ratio (SNR), Signal to Interference and Noise Ratio (SINR), and bit error rate (or packet error rate).

Storage unit 113 stores, for example, messages (e.g., transmission data or reception data). Storage unit 113 may store, for example, information on the control of message forwarding (to be described later).

Controller 114 controls, for example, transmitting, receiving, and/or forwarding messages.

For example, controller 114 may generate information (hereinafter, referred to as “radio device information”) on another radio device with which radio device 101 can communicate, based on the measured result of the reception quality (e.g., RSSI) in quality measurer 112. The radio device information may be, for example, a list indicating another radio device with which radio device 101 can communicate.

For example, controller 114 determines a group to which another radio device belongs. For example, controller 114 may determine a group to which the destination radio device of the received message belongs. For example, controller 114 may determine whether the received message is a message addressed to a group to which radio device 101 that has received the message belongs (hereinafter, also referred to as “same group” for convenience) or a message addressed to another group different from that group (hereinafter, also referred to as “another group” for convenience).

Further, controller 114 may determine, for example, a group to which another radio device capable of communication with radio device 101 belongs. For example, controller 114 may generate information indicating whether another radio device belongs to the same group as radio device 101 (hereinafter, referred to as “group information”). The group information may be, for example, information indicating whether another radio device capable of communication with radio device 101 belongs to “same group” or “another group”.

Note that radio device information and group information, for example, may be generated by controller 114 before the message is transmitted (in other words, data communication). Further, radio device information and group information may be, for example, updated periodically or non-periodically. For example, radio device information and group information may be updated when the configuration of radio device 101 or a group is changed. In addition, radio device information and group information may be stored in storage unit 113, for example.

Further, controller 114 controls, for example, the forwarding (in other words, relaying) of a message received from another radio device based on radio device information, group information, and the group to which the destination radio device of the received message belongs. Also, controller 114 may control transmission and reception (e.g., transmission, reception, and forwarding) of a message based on rules for transmitting a message, which will be described later.

[Example of Radio Device Operation]

An exemplary operation of radio device 101 in the above-described radio communication network 100 will be described.

[Transmission Rules]

Each radio device 101 in radio communication network 100 controls, for example, transmission and reception of a message (e.g., transmission, reception, and forwarding) based on transmission rules including the following Rules 1 to 8.

<Rule 1>

When the destination of the received message is a radio device in the same group, radio device 101 may not transmit the message to a radio device in another group.

For example, when the destination information of the message indicates the same group (or a radio device belonging to the same group), radio device 101 may forward the message to another radio device in the same group, and may not forward the message to a radio device in another group. In other words, when the destination information of the message indicates the first group to which radio device 101 belongs, radio device 101 may select a radio device (in other words, candidate radio device) in the first group as the forwarding destination of the message, and may not select a radio device in the second group different from the first group.

Note that a message forwarded (in other words, transmitted by radio) based on <Rule 1> may be receivable by radio device 101 in another group. Thus, for example, when the destination radio device of the message forwarded from a radio device of another group belongs to the other group, radio device 101 may discard the message (in other words, may not forward the message). For example, radio device 101 may discard the received message when the destination information of the message indicates the second group different from the first group to which radio device 101 belongs and the radio device of the transmission source of the received message belongs to the second group. In other words, in Rule 1, not forwarding a message in a radio device of the transmission side (in other words, not selecting as a candidate radio device of the forwarding destination) corresponds to the radio device of the reception side discarding the message.

<Rule 2>

When the destination of the received message is another group and radio device 101 can transmit the message to a radio device in the other group, radio device 101 may not transmit the message in the same group.

For example, when the destination radio device of the message belongs to another group and radio device 101 can communicate with a radio device in the other group, radio device 101 may forward the message to a radio device in the other group and may not forward the message to another radio device in the same group. In other words, when the destination information of the message indicates the second group different from the first group to which radio device 101 belongs, radio device 101 may select a radio device (in other words, candidate radio device) in the second group as the forwarding destination of the message, and may not select a radio device in the first group.

Note that a message forwarded (in other words, transmitted by radio) based on <Rule 2> may be also receivable by radio device 101 in the same group. Thus, radio device 101, for example, may discard the message (in other words, may not forward the message) when the destination radio device of the message forwarded from another radio device in the same group belongs to another group and the other radio device can communicate with a radio device in the other group. For example, radio device 101 may discard the received message when the destination information of the message indicates the second group different from the first group to which radio device 101 belongs and a radio device of the transmission source of the received message belongs to the first group. In other words, in <Rule 2>, not forwarding the message in a radio device of the transmitting side (in other words, not selecting as a candidate radio device of the forwarding destination) corresponds to a radio device of the receiving side discarding the message.

<Rule 3>

When forwarding the second message after forwarding the first message once, radio device 101 may perform a process related to the forwarding of the second message (e.g., control of the forwarding) after waiting for a predetermined time (e.g., referred to as a delay time). Here, the first message and the second message may be the same or different from each other.

In <Rule 3>, the condition for performing the message forwarding after the lapse of the predetermined delay time is not limited to the case where the message is forwarded once, and may be the case where the message is forwarded a predetermined number of times (e.g., two or more).

Further, the delay time in <Rule 3> is not limited to a fixed value, and may be a variable value. For example, the delay time may be set in units of radio devices or in units of groups.

<Rule 4>

When radio device 101 confirms the transmission of the same message from another radio device before forwarding the message, radio device 101 may cancel the transmission (in other words, forwarding) of the message.

For example, when radio device 101 receives the same message as the message received from the first radio device from the second radio device different from the first radio device, radio device 101 may discard the received message.

<Rule 5>

Radio device 101 may not transmit (in other words, forward) a message to a radio device of the transmission source of the message or to a group of the transmission source of the message. In other words, radio device 101 may not select a radio device of the transmission source of the message or a radio device in the group of the transmission source of the message as the forwarding destination of the message.

Note that a message to be forwarded (in other words, transmitted by radio), for example, may be receivable by radio device 101 present in the vicinity of the radio device of the transmission source. Thus, for example, radio device 101 of the transmission source of the message or radio device 101 belonging to the group of the transmission source of the message may discard (in other words, may not forward) the message transmitted from a radio device of another group to which the message has been forwarded.

For example, in FIG. 3, when the message received from a radio device in group 103 is the same as the message that has been forwarded to a radio device in group 103, radio device 101 in group 102 may discard the received message. In other words, in <Rule 5>, not forwarding the message to a radio device of the transmitting side (in other words, not selecting the radio device as a candidate radio device of a forwarding destination) corresponds to a radio device of the receiving side discarding the message.

<Rule 6>

Radio device 101 may not transmit a message that has been transmitted. In other words, when the received message is the same as the previously forwarded message, radio device 101 may cancel the forwarding of the received message.

<Rule 7>

A transmission path of the response (or referred to as response signal) to the message (e.g., also referred to as a response path or a return path) may be the same path as a transmission path of the message (e.g., referred to as a request path or forward path).

<Rule 8>

When the destination radio device of the message is not radio device 101 and no radio device of the forwarding destination is present according to <Rule 2> and <Rule 5>, radio device 101 may forward the message to another radio device in the same group.

The transmission rules have been described above.

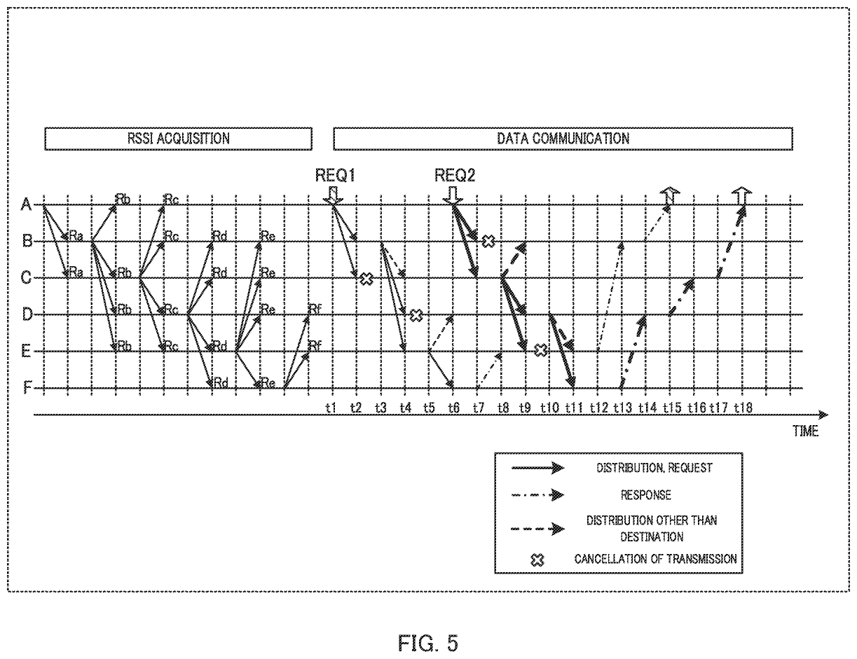

FIG. 5 is a sequence diagram illustrating an operation example of the radio communication network 100 according to the embodiment of the present disclosure.

In FIG. 5, for example, radio communication network 100 includes six radio devices 101 (radio devices A to F) as illustrated in FIG. 3.

[RSSI Acquisition]

For example, each radio device 101 holds information on another radio device (e.g., radio device information) that can communicate with each radio device 101 and information on a group (e.g., group information) to which a radio device included in radio device information belongs, before data communication.

For example, as illustrated in FIG. 5, radio device 101 transmits and receives information including an RSSI (e.g., referred to as RSSI information). For example, in radio device 101, quality measurer 112 may measure the RSSI, transmitter/receiver 111 may perform at least one of transmission and reception of the RSSI information, and storage unit 113 may store RSSI information of another radio device. In radio device 101, controller 114 may determine whether another radio device belongs to the same group as radio device 101 or a different group from the group of radio device 101 (in other words, another group) based on RSSI information.

In FIG. 5, the pieces of RSSI information generated by each radio device 101 based on the RSSIs of signals transmitted from radio devices A, B, C, D, E, and F are represented as “Ra”, “Rb”, “Rc”, “Rd”, “Re”, and “Rf”, respectively.

As an example, radio device B illustrated in FIG. 5 will be described.

In FIG. 5, radio device B holds RSSI information (e.g., Ra, Rc, Rd, and Re) for radio devices A, C, D, and E. Thus, for example, radio device information (information on a communicable radio device) held by radio device B includes radio devices A, C, D, and E.

Group information held by radio device B may indicate that radio devices A and C belong to the same group (e.g., group 102) and radio devices D and E belong to another group (e.g., group 103). Note that the group determination may be based on, for example, the RSSI corresponding to the radio device of the determination target.

In FIG. 5, other radio devices A, C to F may hold radio device information and group information in the same manner as radio device B.

The operation related to obtaining radio device information and group information described above may be performed, for example, periodically or non-periodically while data communication is not performed. For example, radio device information and group information may be updated at every predetermined time. Alternatively, for example, radio device information and group information may be updated when the topology of radio communication network 100 changes due to a change such as deletion or addition of a radio device.

Each radio device 101 may be in a communicable state after completion of the operation of generating (or updating) radio device information and group information.

Not that the method for obtaining an RSSI in radio device 101 illustrated in FIG. 5 is an example, and is not limited thereto.

[Data Communication]

In FIG. 5, a case where radio device A transmits a request message twice (REQ 1 and REQ 2) to radio device F will be described as an example. The request message may be, for example, information requesting to obtain information which radio device F holds.

In the example described in FIG. 5, the radio device of the transmission source of the request message is radio device A, and the destination radio device of the request message is radio device F.

<About Request Message REQ 1>

At time t1, request message REQ 1 addressed to radio device F is inputted into radio device A. Here, radio device A may not transmit a message to another group (e.g., group 103). Radio device A then, for example, transmits request message REQ 1 to radio devices B and C in a communicable state in group 102.

Request message REQ 1 received by radio device B is a message addressed to radio device F belonging to group 103 different from group 102 to which radio device B belongs. Further, radio device B can communicate with radio devices D and E belonging to group 103. Thus, at time t3, for example, radio device B forwards request message REQ 1 received at time t2 to radio devices D and E belonging to group 103 based on <Rule 2>.

Here, since radio device B can communicate with radio device C in group 102, request message REQ 1 forwarded by radio device B can also be received by radio device C (e.g., a broken arrow extending from radio device B to radio device C illustrated in FIG. 5. Distribution other than the destination). Thus, radio device C cancels the forwarding operation of request message REQ 1 received at time t2 based on <Rule 4> (a cross mark illustrated in FIG. 5 means a cancellation of transmission).

In FIG. 5, request message REQ 1 received by radio device E is a message addressed to radio device F belonging to group 103 to which radio device E belongs. Thus, at time t5, radio device E forwards request message REQ 1 received at time t4 to radio device F belonging to group 103 based on <Rule 1>, for example. At time t6, radio device F receives request message REQ 1 addressed to radio device F.

Radio device D receives request message REQ 1 that has been forwarded by radio device B at time t4 also from radio device E at time t6. Then, radio device D cancels the forwarding operation of request message REQ 1 received at time t4 based on <Rule 4> (a cross mark illustrated in FIG. 5 means a cancellation of transmission).

Note that, in FIG. 5, a case where radio device B forwards request message REQ 1 and radio device C cancels the forwarding of request message REQ 1 at time t2 and time t3, and radio device E forwards request message REQ 1 and radio device D cancels the forwarding of request message REQ 1 at time t4 and t5 has been described as an example, but the example is not limited thereto. For example, a radio device that can execute a message (e.g., request message REQ 1) forwarding process faster among a plurality of radio devices that have received a message executes the message forwarding process, and another radio device may cancel the forwarding process based on <Rule 3>. This operation prevents the same message from being forwarded in an overlapped manner in radio communication network 100, and thus the data transmission efficiency can be enhanced.

In FIG. 5, the transmission path of the response to request message REQ 1 may be, for example, determined based on the transmission path of request message REQ 1 based on <Rule 7>. For example, in FIG. 5, the transmission path of request message REQ 1 is radio devices A, B, E, and F. Thus, the transmission paths of the response to requested messages REQ 1 may be radio devices F, E, B and A.

Each radio device 101, for example, may record route information including information on radio device 101 when request message REQ 1 is forwarded. Each radio device 101 may determine whether to forward the response to request message REQ 1 based on the record information.

<About Request Message REQ 2>

Request message REQ 2 is inputted to radio device A at time t6 after radio device A transmits request message REQ 1, for example. As described above, radio device A may not transmit a message to another group (e.g., group 103). Thus, radio device A, for example, transmits request message REQ 2 to radio devices B and C in a communicable state in group 102.

At time t7 illustrated in FIG. 5, radio devices B and C receive request message REQ 2 from radio device A. Here, radio device B performs the forwarding operation of request message REQ 1. In other words, radio device C does not perform the forwarding operation of request message REQ 1. Thus, radio device B waits to perform the forwarding operation of request message REQ 2 received at time t7 for a predetermined delay time based on <Rule 3>.

The predetermined delay time may be determined based on, for example, a time required for radio device 101 to forward a message (hereinafter referred to as a forwarding processing time). For example, the delay time may be set to a time equal to or less than twice the forwarding processing time. For example, when the delay time is set to 50% of the forwarding processing time in radio device 101, the forwarding processing time in radio device 101 takes 1.5 times compared with the case where there is no delay. Note that the delay time is not limited to 50% of the forwarding processing time, and may be another rate. The delay time is not limited to the case based on the forwarding processing time, and may be set based on, for example, the degree of dispersion of the communication amount and the allowable forwarding delay time.

Request message REQ 2 received by radio device C at time t7 is a message addressed to radio device F belonging to group 103 different from group 102 to which radio device C belongs. Further, radio device C can communicate with radio devices D and E belonging to group 103. Thus, for example, while radio device B is waiting (in other words, pending) to perform the forwarding operation, radio device C forwards request message REQ 2 received at time t7 to radio devices D and E belonging to group 103 at time t8 based on <Rule 2>.

Here, since radio device C can communicate with radio device B in group 102, request message REQ 2 forwarded by radio device C can also be received by radio device B (e.g., a broken arrow extending from radio device C to radio device B illustrated in FIG. 5). Therefore, radio device B cancels the forwarding operation of request message REQ 2 received at time t7 based on <Rule 4> (a cross mark illustrated in FIG. 5 means a cancellation of transmission).

In FIG. 5, in the same manner as radio device B, radio device E waits to perform the forwarding operation of request message REQ 2 received at time t9 for a predetermined delay time based on <Rule 3>, since radio device E has performed the forwarding operation of request message REQ 1. While radio device E is waiting (in other words, pending) to perform the forwarding operation, radio device D forwards request message REQ 2 received at time t9 to radio device F belonging to group 103 at time t10 based on <Rule 1>. Radio device F receives request message REQ 2 addressed to radio device F at time t11.

Radio device E receives request message REQ 2 forwarded by radio device C at time t9 also from radio device D at time t11. Thus, radio device E cancels the forwarding operation of request message REQ 2 received at time t9 based on <Rule 4> (a cross mark illustrated in FIG. 5 means a cancellation of transmission).

As described above, in FIG. 5, a radio device that forwards a plurality of messages (e.g., two messages) to be transmitted from radio device A to radio device F is switched between radio devices D and E each time the message is forwarded. In other words, since it is unlikely that either radio device D or E forwards messages continuously, the communication load can be distributed in radio communication network 100.

The transmission path of the response to request message REQ 2 may be, for example, determined based on the transmission path of request message REQ 2 based on <Rule 7>. For example, in FIG. 5, the transmission path of requested messages REQ 2 is radio devices A, C, D, and F. Thus, the transmission path of the response to request message REQ 2 may be radio devices F, D, C and A.

As described above, request message REQ 2 is forwarded by radio devices C and D while radio devices B and E that have forwarded request message REQ 1 are waiting to perform the forwarding operation. In other words, according to the setting of the delay time based on <Rule 3>, for example, radio devices B and E are less likely to forward request message REQ 2 and radio devices C and D are more likely to forward request message REQ 2 at time t8 and t10 illustrated in FIG. 5. By this operation, the transmission path of a plurality of messages (e.g., two messages) transmitted from radio device A to radio device F can be switched between radio devices B and C and between radio devices D and E each time the message is forwarded in FIG. 5. In other words, the possibility that either radio device B or C, or either radio device D or E forwards messages continuously is reduced. Therefore, the communication load can be dispersed in radio communication network 100.

Next, an operation example of radio device 101 in radio communication network 100 will be described.

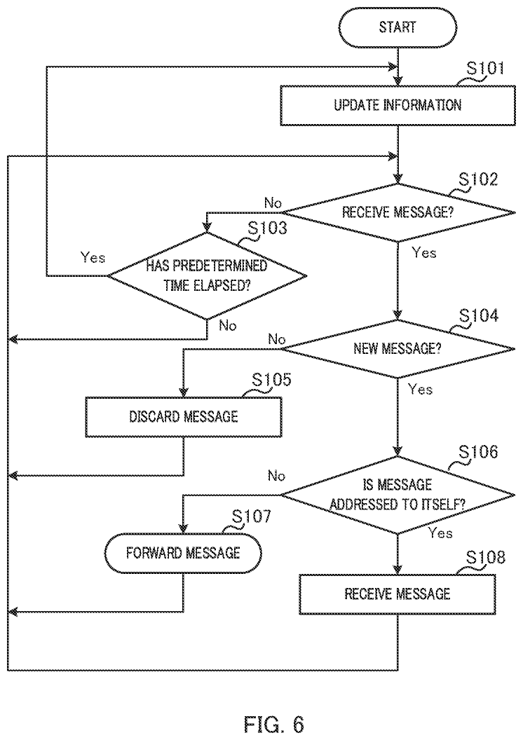

FIG. 6 is a flowchart illustrating an operation example of radio device 100.

In FIG. 6, radio device 101 updates information such as radio device information and group information (S101). For example, radio device 101 may detect another radio device that can communicate with radio device 101 by an RSSI measurement, and may update radio device information (e.g., a list of communicable radio devices) based on the detected result. In addition, radio device 101, for example, may determine whether the communicable radio device is a radio device in the same group or a radio device in another group based on the measured result of the RSSI, and may update group information.

For example, radio device 101 is in a waiting state for receiving a message (e.g., a message waiting state) after information is updated.

Radio device 101, for example, determines whether radio device 101 has received a message (S102). When radio device 101 has received no message (S102: No), radio device 101, for example, determines whether a predetermined period for updating information has elapsed (S103). When the predetermined time has elapsed (S103: Yes), radio device 101 returns to the process of S101 and updates information. On the other hand, when the predetermined time has not elapsed (S103: No), radio device 101 returns to the process of S102 and continues the waiting state for receiving a message.

Note that, in FIG. 6, a case where information is updated every time a predetermined time elapses is described, but the present disclosure is not limited thereto. The information may be updated, for example, every time a predetermined time elapses (in other words, regularly or periodically), or may be performed when a certain event (e.g., a change of topology) occurs (in other words, non-regularly or non-periodically).

When receiving a message in FIG. 6 (S102: YES), radio device 101 determines whether the received message is a new message (S104). In other words, radio device 101 determines whether the received message is different from the previously forwarded message. When the received message is not a new message (S104: No), radio device 101 discards the message (S105), for example, and returns to the process of S102.

The processes of S104 and S105 illustrated in FIG. 6 correspond to the above-described <Rule 6>.

When the received message is a new message (S104: Yes), radio device 101 determines whether the received message is a message addressed to radio device 101 (in other words, addressed to itself) (S106). When the received message is not addressed to itself (S106: No), radio device 101 performs the process of forwarding the message (S107). On the other hand, when the received message is addressed to itself (S106: Yes), radio device 101 performs the process of receiving the message (S108). Radio device 101 may, for example, return to the process of S102 after processing S107 or processing S108.

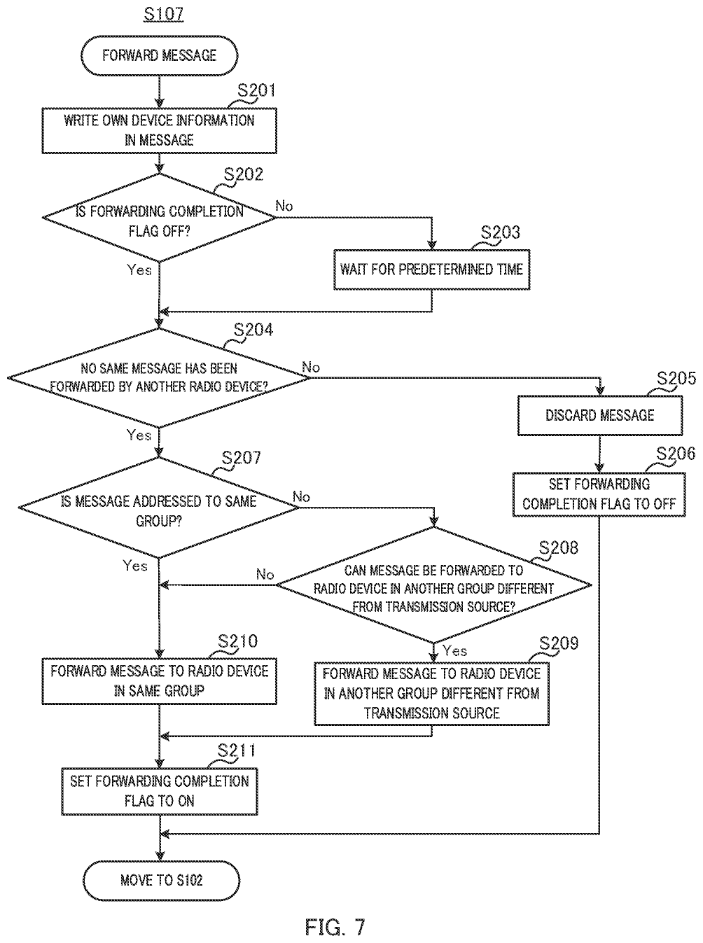

FIG. 7 is a flowchart illustrating an operation example of a message forwarding process of S107 described in FIG. 6.

In FIG. 7, radio device 101 writes information on radio device 101 (e.g., the own device information or route information) in the received message (S201). For example, the transmission path of the response to the message may be determined in each radio device 101 based on <Rule 7> according to this information.

Radio device 101 may determine whether a forwarding completion flag is OFF (S202).

The “forwarding completion flag” may be, for example, information indicating whether radio device 101 has forwarded another message within a predetermined period of time before forwarding the message. For example, the forwarding completion flag may be set to ON when radio device 101 forwards the message. Further, for example, the forwarding completion flag may be set to OFF when radio device 101 cancels the forwarding of the message. In addition, the forwarding completion flag may be set to OFF before data communication (e.g., at the time of the initial setting).

When the forwarding completion flag is ON (S202: No) in FIG. 7, radio device 101 waits for a predetermined delay time (S203). This causes another radio device 101 to forward the message, and thus can prevents communication of specific radio device 101 from being concentrated. The processes of S202 and S203 described in FIG. 7 correspond to the above-described <Rule 3>.

When the forwarded flag is OFF (S202: Yes), or after S203 is processed, radio device 101 determines whether another radio device has not forwarded the same message as the received message (S204). When another radio device has forwarded the same message (S204: No), radio device 101 discards the message (S205) and sets the forwarding completion flag to OFF (S206). The processes of S204, S205, and S206 illustrated in FIG. 7 correspond to the above-described <Rule 4>.

When another radio device has not forwarded the same message (S204: Yes), radio device 101 determines whether the received message is a message addressed to a radio device in the group (e.g., the same group) to which radio device 101 belongs (S207).

When the message is not a message addressed to a radio device in the same group (S207: No), radio device 101 determines whether the message can be forwarded to a radio device in another group different from the group of the transmission source (S208). When a message can be forwarded to a radio device in another group different from the group of the transmission source (S208: Yes), radio device 101 forwards the message to a radio device that is different from the radio device of the transmission source and that belongs to another group (S209). The processes of S207, S208, and S209 illustrated in FIG. 7 correspond to the above-described <Rule 2> or <Rule 5>.

On the other hand, when a massage may not be transmitted to a radio device in another group different from the group of the transmission source (S208: No), radio device 101 forwards the message to a radio device in the same group (S210). The processes of S207, S208, and S210 illustrated in FIG. 7 correspond to the above-described <Rule 8>.

When the message is a message addressed to a radio device in the same group (S207: YES), radio device 101 forwards the message to the radio device in the same group (S210). In other words, when the message is a message addressed to a radio device in the same group, radio device 101 may not forward the message to a radio device in another group. The processes of S207 and S210 illustrated in FIG. 7 correspond to the above-described <Rule 1>.

When the message is forwarded in the process of S209 or S210, radio device 101 sets the forwarding completion flag to ON (S211). Radio device 101 may, for example, return to the process of S102 illustrated in FIG. 6 after processing S211.

The operation example of radio device 101 has been described above.

In the present embodiment, in radio communication network 100, radio device 101 determines, based on the destination information of the received message and information on the group to which another radio device (e.g., candidate radio device) capable of communication with radio device 101 belongs, a candidate radio device that is not selected as the forwarding destination of the received message. For example, radio device 101 does not select a radio device in another group as the forwarding destination of the received message when the destination information of the message indicates the same group (corresponding to <Rule 1> described above). Further, radio device 101, for example, does not select a radio device in the same group as the forwarding destination of the received message when the destination information of the message indicates another group (corresponding to <Rule 2> described above).

By the above processes, in radio communication network 100, radio device 101 can forward a message to a radio device in either the same group or another group in which the destination radio device belongs without selecting a representative device in each group. Therefore, according to the present embodiment, since the procedure of selecting a representative device as described in PTL 1 is unnecessary, the time until data communication is available can be shortened. Also, according to the present embodiment, since radio device 101 does not forward the message addressed to a radio device in the same group to another group and may not forward the message addressed to a radio device in another group to the same group, communication amount can be reduced.

Further, for example, when a message is forwarded to radio device 101 in another group (not illustrated) that can communicate with both groups 102 and 103 illustrated in FIG. 5, that radio device 101 may not forward (e.g., discard) the message based on <Rule 2>. This results in reducing the communication amount.

In addition, in the present embodiment, when forwarding a subsequent message after forwarding a message, radio device 101, for example, waits for a predetermined delay time and then performs an operation related to message forwarding (corresponding to <Rule 3> described above). This process increases the possibility that a message is forwarded in another radio device different from the radio device waiting for the delay time among the plurality of radio devices 101 that can forward the same message at approximately the same time. Thus, messages are more likely to be forwarded dispersively by a plurality of radio devices in radio communication network 100. For example, when there are a plurality of communication paths of a message, an imbalance in communication in some of the paths of the plurality of communication paths can be reduced.

Further, when the same message as the received message is forwarded from another radio device, radio device 101 cancels the forwarding of the message (corresponding to <Rule 4> described above). This process reduces the possibility that another radio device different from the radio device that has actually forwarded the message forwarding the message, and thus the same message is hardly forwarded from a plurality of radio devices 101 at the same time in radio communication network 100. This results in reducing the communication amount.

Moreover, in the present embodiment, radio device 101, for example, does not transmit a message to the radio device of the transmission source or the group of the transmission source of the message (corresponding to <Rule 5> described above). In addition, radio device 101 does not transmit a message that has already been transmitted (corresponding to <Rule 6> described above). This process allows reduction of repeatedly forwarding the same message in the same path, and thus results in reducing the communication amount.

As described above, it is possible to enhance data transmission efficiency in the radio communication network according to the present embodiment.

[Variation]

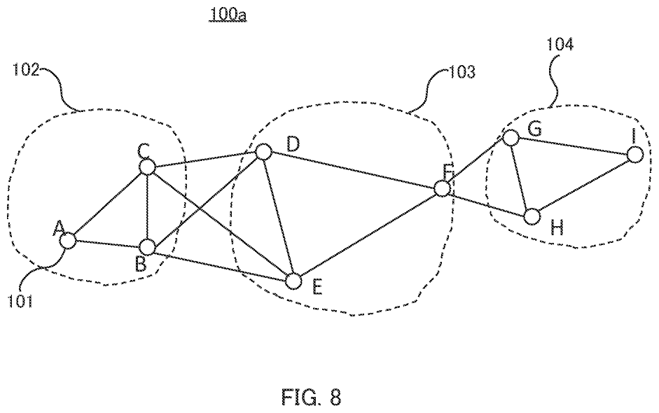

FIG. 8 is a diagram illustrating a configuration example of radio communication network 100a according to a variation. Radio communication network 100a illustrated in FIG. 8 includes, for example, a configuration in which group 104 is added to the configuration of radio communication network 100 illustrated in FIG. 3. In FIG. 8, for example, radio device G, radio device H, and radio device I belong to group 104.

In FIG. 8, the connection relations of radio device A to F are the same as those in FIG. 3. Also in FIG. 8, radio device G may communicate by radio with each of radio devices F, H, and I; radio device H may communicate by radio with each of radio devices F, G, and I; and radio device I may communicate by radio with each of radio devices G and H.

As illustrated in FIG. 8, communication between radio device 101 belonging to group 102 and radio device 101 belonging to group 104 passes through group 103.

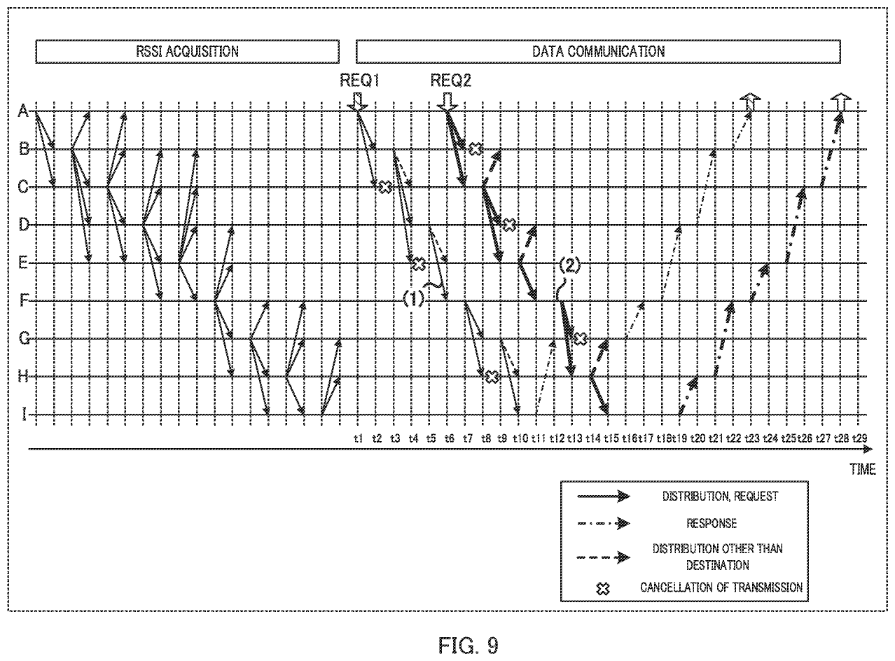

FIG. 9 is a sequence diagram illustrating an operation example of radio communication network 100a according to the variation.

In FIG. 9, each radio device 101 (e.g., radio devices A to I) may control transmission and reception (e.g., forwarding) of a message based on the transmission rules (<Rule 1> to <Rule 8>), similarly to the embodiment described above, for example.

In FIG. 9, a case where radio device A transmits a request message twice (REQ 1 and REQ 2) to radio device I will be described as an example.

As illustrated in FIG. 9, similarly to the example in FIG. 5, each radio device 101, for example, holds information on another radio device that can communicate with each radio device 101 (e.g., radio device information) and information on the group (e.g., group information) to which the radio device included in the radio device information belongs, before data communication.

Then, in FIG. 9, request message REQ 1 addressed to radio device I is inputted to radio device A at time t1. Note that, from time t1 to time t4 and from time t6 to time t23 illustrated in FIG. 9, each radio device 101, for example, controls transmission and reception (e.g., transmission, forwarding, reception, or cancellation of forwarding) of request message REQ 1 based on the transmission rules, in the same manner as in the above-described embodiment.

At time t4 illustrated in FIG. 9, radio devices D and E (radio devices in group 103) receive request message REQ 1 addressed to radio device I (a radio device in group 104) from radio device B (a radio device in group 102).

Here, the destination of requested message REQ 1 received in radio devices D and E is a radio device of another group (group 104), and radio devices D and E may not transmit the message to group 104. Further, radio devices B and C that can communicate with radio devices D and E and are in another group belong to group 102 of the transmission source of request message REQ 1.

Therefore, there is no radio device that may forward the message among radio devices D and E when the case is based on <Rule 2> and <Rule 5>. Thus, in FIG. 9, radio device D (may be radio device E) may forward the message to radio device F, which is another radio device in group 103 to which radio device D belongs, at time t5 based on <Rule 8>, for example (the portion illustrated as (1) in FIG. 9).

Further, in FIG. 9, at time t6, request message REQ 2 addressed to radio device I is inputted to radio device A. Note that, from time t6 to time t11 and from time t13 to time t28 illustrated in FIG. 9, each radio device 101, for example, controls transmission and reception (e.g., transmission, forwarding, reception, or cancellation of forwarding) of request message REQ 2 based on the transmission rules, in the same manner as in the above-described embodiment.

At time t11 illustrated in FIG. 9, radio device F receives request message REQ 2 addressed to radio device I from radio device E.

Here, as illustrated in FIG. 9, radio device F forwards request message REQ 1 at time t7. Thus, radio device F waits to perform the forwarding operation of request message REQ 2 received at time t7 for a predetermined delay time based on <Rule 3>. Note that, in FIG. 9, no radio device capable of communication with a radio device in group 104 is present in group 103 other than radio device F. Thus, as illustrated in FIG. 9, radio device F forwards request message REQ 2 to radio devices G and H in group 104 after the predetermined delay time has elapsed (the portion illustrated as (2) in FIG. 9).

The embodiment of the present disclosure has been described above.

Note that the configuration of the radio communication network described in the above embodiment and the variation is an example, and is not limited thereto. For example, at least one of the number of groups (or the number of radio devices 101) in the radio communication network, the number of radio devices 101 belonging to each group, and the connection relation between radio devices 101 may be different from the examples described in FIGS. 3 and 8.

In addition, the request message and the response have been described as the examples of signals transmitted (e.g., distributed or requested) in radio communication network 100, but the transmitted signals are not limited thereto and may be another type of signals.

The description has been given of embodiments with reference to the drawings, but the present disclosure is not limited to the examples. It is apparent that variations or modifications in the category described in the claims may be conceived by a person skilled in the art. It is to be understood that such variations or modifications fall within the technical scope of the present disclosure. In addition, component elements in the embodiment may be optionally combined without departure from the spirit of the present disclosure.

In the embodiments described above, the present disclosure has been described for an exemplary configuration using hardware. However, the present disclosure can be realized by software in cooperation with hardware.

Further, the functional blocks used in the description of the embodiments described above are typically implemented as a Large Scale Integration (LSI) as an integrated circuit. The integrated circuit may control each functional block used in the description of the above embodiment, and may include an input and an output. Those integrated circuits may be individually formed as one chip, or may be formed as one chip so as to include a part or all. The integrated circuit here is referred to as an LSI, but may be referred to as an Integrated Circuit (IC), a Small Scale Integration (SSI), a Middle Scale Integration (MSI), a system LSI, a super LSI, a Very Large Scale Integration (VLSI), or an ultra LSI depending on a difference in the degree of integration.

The technique of implementing an integrated circuit is not limited to the LSI and may be realized by using a dedicated circuit or a general-purpose processor. A Field Programmable Gate Array (FPGA) that can be programmed or a reconfigurable processor in which the connections and the settings of circuit cells disposed inside the LSI can be reconfigured may be used after the manufacture of the LSI.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (IoT)”.

The communication may include exchanging data through, for example, a cellular system, a radio LAN system, a satellite system, etc., and various combinations thereof. The communication apparatus may include a device such as a controller or a sensor which is coupled to a communication device performing a function of communication described in the present disclosure. For example, the communication apparatus may include a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

In the above description, the term “unit” or “-er” used for the name of a component may be replaced with another term such as “circuitry”, “assembly”, “device”, “unit”, or “module”.

### SUMMARY OF EMBODIMENTS

A radio communication apparatus according to the embodiment of the present disclosure is a radio communication apparatus in a wireless mesh network, and includes: reception circuitry, which, in operation, receives a radio signal; and control circuitry, which, in operation, determines a candidate radio device that is not selected as a forwarding destination of the received radio signal, based on destination information of the received radio signal and information on a group to which another candidate radio device capable of communication belongs.

In the embodiment of the present disclosure, when the destination information indicates a certain group that is different from a first group to which the radio communication apparatus belongs, the control circuitry does not select the candidate radio device in the first group as a forwarding destination of the radio signal, the certain group being referred to as a second group; and when the destination information indicates the first group, the control circuitry does not select the candidate radio device in the second group as a forwarding destination of the radio signal.

In the embodiment of the present disclosure, the control circuitry discards the received radio signal when the destination information indicates a certain group different from a first group to which the radio communication apparatus belongs and a radio device of a forwarding source of the received radio signal belongs to the first radio group, the certain group being referred to as a second group; and the control circuitry discards the received radio signal when the destination information indicates the second group and the radio device of the forwarding source of the received message belongs to the second group.

In the embodiment of the present disclosure, the control circuitry selects the candidate radio device in the second group as a forwarding destination of the radio signal when the destination information indicates the second group; and the control circuitry selects the candidate radio device in the first group as a forwarding destination of the radio signal when the destination information indicates the first group.

In the embodiment of the present disclosure, the control circuitry waits for a predetermined time when a certain radio signal is forwarded after a first radio signal is forwarded, the certain radio signal being referred to as a second radio signal.

In the embodiment of the present disclosure, the predetermined time is configured to a time twice or less than twice of a forwarding processing time of the radio signal.

In the embodiment of the present disclosure, the control circuitry discards the radio signal when a same signal as the radio signal received from a first radio device is received from a second radio device different from the first radio device.

In the embodiment of the present disclosure, the control circuitry does not select a radio device of a transmitting source of the radio signal or the candidate radio device in a group of the transmitting source of the radio signal as a forwarding destination of the radio signal.

In the embodiment of the present disclosure, the control circuitry discards the received radio signal when the radio signal received from a radio device in a certain group different from a first group to which the radio communication apparatus belongs is identical to a signal that has been forwarded to the candidate radio device in the certain group being referred to as a second group.

In the embodiment of the present disclosure, the control circuitry discards the received radio signal when the received radio signal is same as a radio signal that has been previously forwarded.

In the embodiment of the present disclosure, a transmission path of a response signal to the radio signal is determined based on a transmission path of the radio signal in the wireless mesh network.

In a radio communication method according to the embodiment of the present disclosure, a radio communication apparatus in a wireless mesh network receives a radio signal, and determines a candidate radio device that is not selected as a forwarding destination of the received radio signal based on destination information of the received radio signal and information on a group to which another candidate radio device capable of communication belongs.

A radio communication system according to the embodiment of the present disclosure includes a first radio device in a wireless mesh network and a plurality of second radio devices capable of communication with the first radio device, wherein the first radio device receives a radio signal, and determines a candidate radio device that is not selected as a forwarding destination of the received radio signal among the plurality of the second radio devices based on destination information of the received radio signal and information on a group to which the plurality of the second radio devices belong.

The disclosure of Japanese Patent Application No. 2020-014839, filed on Jan. 31, 2020, including the specification, drawings and abstract, is incorporated herein by reference in its entirety.

### INDUSTRIAL APPLICABILITY

The present disclosure is applicable to a radio communication system.

### REFERENCE SIGNS LIST

101 Radio device
111 Transmitter/receiver
112 Quality measurer
113 Storage unit
114 Controller

1. A radio communication apparatus in a wireless mesh network, the radio communication apparatus comprising:
reception circuitry, which, in operation, receives a radio signal; and
control circuitry, which, in operation, determines a candidate radio device that is not selected as a forwarding destination of the received radio signal, based on destination information of the received radio signal and information on a group to which another candidate radio device capable of communication belongs.

2. The radio communication apparatus according to claim 1, wherein
when the destination information indicates a certain group that is different from a first group to which the radio communication apparatus belongs, the control circuitry does not select the candidate radio device in the first group as a forwarding destination of the radio signal, the certain group being referred to as a second group; and
when the destination information indicates the first group, the control circuitry does not select the candidate radio device in the second group as a forwarding destination of the radio signal.

3. The radio communication apparatus according to claim 1, wherein
the control circuitry discards the received radio signal when the destination information indicates a certain group different from a first group to which the radio communication apparatus belongs and a radio device of a forwarding source of the received radio signal belongs to the first radio group, the certain group being referred to as a second group; and
the control circuitry discards the received radio signal when the destination information indicates the second group and the radio device of the forwarding source of the received message belongs to the second group.

4. The radio communication apparatus according to claim 2, wherein
the control circuitry selects the candidate radio device in the second group as a forwarding destination of the radio signal when the destination information indicates the second group; and
the control circuitry selects the candidate radio device in the first group as a forwarding destination of the radio signal when the destination information indicates the first group.

5. The radio communication apparatus according to claim 1, wherein
the control circuitry waits for a predetermined time when a certain radio signal is forwarded after a first radio signal is forwarded, the certain radio signal being referred to as a second radio signal.

6. The radio communication apparatus according to claim 5, wherein
the predetermined time is configured to a time twice or less than twice of a forwarding processing time of the radio signal.

7. The radio communication apparatus according to claim 1, wherein
the control circuitry discards the radio signal when a same signal as the radio signal received from a first radio device is received from a second radio device different from the first radio device.

8. The radio communication apparatus according to claim 1, wherein
the control circuitry does not select a radio device of a transmitting source of the radio signal or the candidate radio device in a group of the transmitting source of the radio signal as a forwarding destination of the radio signal.

9. The radio communication apparatus according to claim 1, wherein
the control circuitry discards the received radio signal when the radio signal received from a radio device in a certain group different from a first group to which the radio communication apparatus belongs is identical to a signal that has been forwarded to the candidate radio device in the certain group being referred to as a second group.

10. The radio communication apparatus according to claim 1, wherein
the control circuitry discards the received radio signal when the received radio signal is same as a radio signal that has been previously forwarded.

11. The radio communication apparatus according to claim 1, wherein
a transmission path of a response signal to the radio signal is determined based on a transmission path of the radio signal in the wireless mesh network.

12. A radio communication method, comprising:
receiving a radio signal by a radio communication apparatus in a wireless mesh network; and
determining, by the radio communication apparatus in the wireless mesh network, a candidate radio device that is not selected as a forwarding destination of the received radio signal, based on destination information of the received radio signal and information on a group to which another candidate radio device capable of communication belongs.

13. A radio communication system, comprising:
a first radio device in a wireless mesh network; and
a plurality of second radio devices capable of communication with the first radio device, wherein
the first radio device receives a radio signal, and
the first radio device determines a candidate radio device that is not selected as a forwarding destination of the received radio signal among the plurality of the second radio devices, based on destination information of the received radio signal and information on a group to which the plurality of the second radio devices belong.
